(19) United States
(12) Patent Application Publication
(10) Pub. No.: US 2022/0110442 A1
(43) Pub. Date: Apr. 14, 2022

(54) All-In-One Shaving System

(71) Applicants: Keith Cardwell, Las Vegas, NV (US); Keith Cardwell, Las Vegas, NV (US)

(72) Inventors: Keith Cardwell, Las Vegas, NV (US); Keith Cardwell, Las Vegas, NV (US)

(21) Appl. No.: 17/200,767

(22) Filed: Mar. 12, 2021

Related U.S. Application Data
(60) Provisional application No. 63/091,771, filed on Oct. 14, 2020.

(51) Int. Cl. A46B 15/00; A45D 27/04; A45D 34/04; A46B 11/00; B26B 21/44; B26B 21/22; B26B 21/52; B26B 21/48

(52) U.S. Cl. CPC A46B 15/0079; A45D 27/04; A45D 34/042; A46B 11/0065; A45D 2034/005; B26B 21/225; B26B 21/522; B26B 21/48; B26B 21/446

(57) ABSTRACT

An all-in-one shaving system having a hollow handle, a neck attachable to the hollow handle, a razor blade movably attachable to the neck and pivotally positioned for use in shaving, a disposable shaving liquid reservoir cartridge, a foot assembly attachable to the opposite end of the hollow handle as the neck, the foot assembly including a shaving brush, a valve housing, and a travel passage through which said shaving liquid travels from the valve assembly of the disposable shaving reservoir cartridge and into the shaving brush. The shaving system further includes a shaving liquid dispensing mechanism wherein activation of dispensing mechanism withdraws shaving liquid from the shaving liquid reservoir through a shaving liquid travel passage to the shaving brush. A method of use includes a user activating the dispensing mechanism, applying shaving liquid to the face with the shaving brush and then shaving with the razor.

### CROSS-REFERENCE TO RELATED APPLICATIONS

The present utility patent application claims priority benefit of the U.S. provisional application for patent Ser. No. 63/091,771 titled “Razor with Shave Cream Reservoir and Brush Applicator,” filed on Oct. 14, 2020 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of shaving razors. More specifically, the present invention relates to a all-in-one shaving system designed to dispense a specific amount of shaving cream through a brush applicator.

### 2. Description of the Related Art

The role of shaving in human history is widely understood. From as early as 3000 BC, humans have been making razors to remove unwanted hair. Shaving is most commonly practiced by men to remove their facial hair. Women also shave to remove their leg and underarm hair.

Over the centuries, shaving products have evolved. Newer blade technologies have been developed. Newer shaving creams and gels have been created. Newer shaving cream and gel applicator technologies have been developed. To this day, though, these products are generally sold separately and are used on a standalone basis. Presently, there exists the need for a shaving razor with a shaving cream or gel dispenser and an applicator brush integrated into a single, easy-to-use unit.

### SUMMARY

The object of the present invention is to provide a shaving system with a shaving razor with a shaving cream or gel dispenser and an applicator brush integrated into a single, easy-to-use unit. A user can apply shaving cream or gel by activating a dispensing mechanism which dispenses shaving cream into a shaving brush. A user can then use the shaving brush to apply shaving cream or gel onto the skin in order to create a lather, to raise hairs to be shaved and to provide a lubricated medium over which a razor can pass.

A further object of the present invention is to provide an all-in-one shaving system which a user can easily transport from one location to another. For example, a user can easily pack away the shaving system and take it on vacations, weekend getaways or business trips. Such a shaving system is designed to provide a high-quality shave with components that are easily replaceable and obtainable.

Another object of the invention is to provide an all-in-one shaving system that provides a high-quality shave which can be performed easily and with affordable components. The all-in-one shaving system includes a brush which is known to produce a better shaving lather which ultimately yields a better shave. Using the all-in-one shaving system, a user can apply custom shaving liquids, gels or foams through an applicator brush and easily use the razor by turning the shaving system around. A user can either use the components of the all-in-one shaving system separately or a user can use the all-in-one shaving system as a single integrated unit.

At its essence, the invention is directed to a shaving system that includes a hollow handle, a razor assembly attachable to one end of the hollow handle including a neck and movably attachable razor blade pivotally positioned for use in shaving, a shaving brush assembly which is attachable to the opposite end of the hollow handle as the razor assembly having a shaving brush, a disposable shaving liquid reservoir cartridge, a valve housing located on the interior of the shaving brush assembly, and a travel passage through the shaving brush assembly which shaving liquid travels from the valve assembly into the said shaving brush, and a shaving liquid dispensing mechanism.

The invention can be easily upgraded and customized with interchangeable components such as, but not limited to, the integration of badger hair shaving brushes. Another example is the use of a hollow handle made from custom materials such as wood or other specialty materials. Furthermore, razor blades of different qualities can be incorporated. Finally, customizations such as a heating element incorporated into the hollow handle for the heating of the shaving liquid. Such an all-in-one shaving system can provide a user with a wide variety of personalization and customization.

A method of shaving using an all-in-one shaving system involves a user releasing the shaving liquid from the disposable shaving liquid reservoir into the shaving brush by activating a dispensing mechanism. The user then applies the shaving liquid which was released into the shaving brush and applying the shaving liquid to a specific area of the body. The user then uses the razor blade of the all-in-one shaving system to shave the are of the body where the shaving liquid was applied.

### BRIEF DESCRIPTION OF THE DRAWINGS

The invention directed by way of example, and not by way of limitation, in the figures of the accompanying drawings and in which like reference numerals refer to similar elements and in which:

FIG. 1 illustrates a front plan view of an exemplary all-in-one shaving system in accordance with an embodiment of the invention;

FIG. 2 is a front exploded view of the all-in-one shaving system in accordance with an embodiment of the invention;

FIG. 3 is a front view of an applicator brush and shaving cream and gel reservoir for a all-in-one shaving system in accordance with an embodiment of the invention; and

FIG. 4 is a front exploded view of an applicator brush and shaving cream and gel reservoir for a all-in-one shaving system in accordance with an embodiment of the invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “an embodiment,” “various embodiments,” etc., may indicate that the embodiment(s) of the invention so described may include particular features, structures, or characteristics. However, not every embodiment necessarily includes the particular features, structures, or characteristics. Further, repeated use of the phrase “in one embodiment,” or “in an exemplary embodiment,” do not necessarily refer to the same embodiment although they may. A description of an embodiment with several components in communication with each other does not imply that all such components are required. On the contrary, a variety of optional components are described to illustrate the wide variety of possible embodiments of the present invention.

As is well known to those skilled in the art, many careful considerations and compromises typically must be made when designing for the optimal manufacture of a commercial implementation of an all-in-one shaving system. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

The exemplary all-in-one shaving system will now be described in detail with reference to embodiments thereof as illustrated in the accompanying drawings.

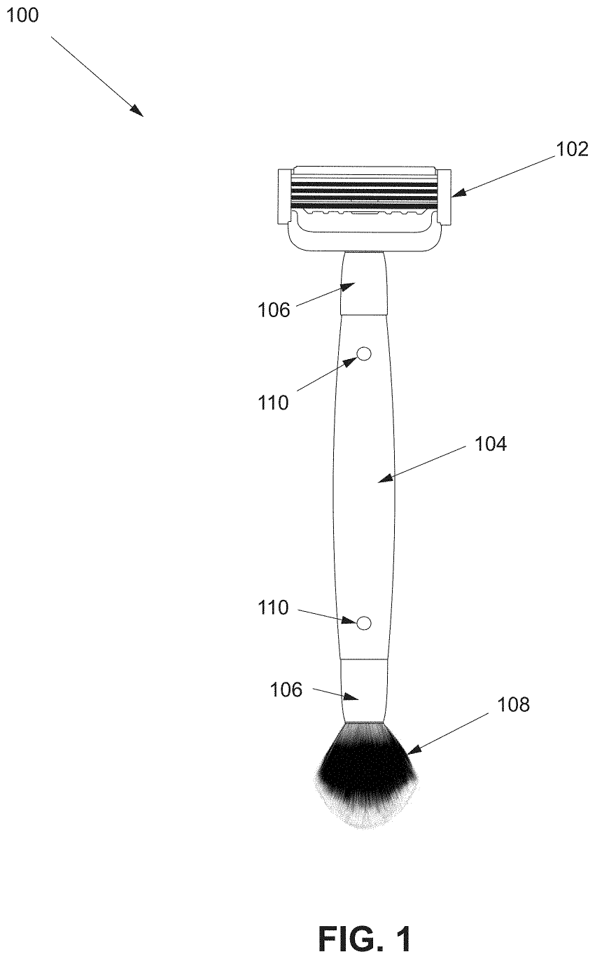

FIG. 1 illustrates a front plan view of an all-in-one shaving system 100 in accordance with an embodiment of the invention. The all-in-one shaving system 100 includes a detachable razor 102, a hollow handle 104, an attachment shroud assembly 106, and a detachable applicator brush 108. The detachable razor 102 and the detachable applicator brush are secured to the hollow handle 104 by an attachment shroud assembly 106. In an embodiment of the invention, the attachment shroud which combines with the detachable razor 102 can be referred to as a neck. In an embodiment of the invention, the assembly created by combining the detachable applicator brush and the attachment shroud can be referred to as a foot. In embodiments of the invention, the neck can attach to one end of the hollow handle and the foot can attach to the opposite end of the hollow handle as the neck. Each attachment shroud assembly 106 also serves as a waterproof barrier for the hollow handle 104. The attachment shroud assemblies 106 have attachment points for accessories. By way of example, and not limitation, the neck includes an attachment shroud assembly that a detachable razor can attach, and the foot includes an attachment shroud assembly that a shaving brush can attach. Each attachment shroud assembly 106 need not take on the same dimensions as the other. Each attachment shroud assembly 106 can connect to the hollow handle by numerous means such as, but not limited to, a simple screw mechanism, a bayonet mount, or a spring-loaded latch mechanism. In such a spring-loaded latch mechanism, the detachable razor 102 and the detachable brush 108 can detach from the hollow handle by the press of a button 110. In one embodiment of the invention, each attachment shroud assembly connects to the hollow handle 104 by a screw mechanism wherein the inner diameter of the attachment shroud assembly 106 is a female end and the hollow handle 104 is a male end. In another embodiment of the invention, each attachment shroud assembly 106 has a slot for a tongue fastening mechanism located in the hollow handle 104.

Persons having skill in the art will readily appreciate that numerous techniques and materials can be used to create each component of the exemplary all-in-one shaving system. For example, and not by way of limitation, the hollow handle 104 may be made from a number of suitable materials such as, but not limited to, plastics, metals, wood, bamboo and/or bone. The attachment shrouds can be made from materials ranging from, but not limited to, metal and metal alloys to plastics to elastomeric compounds.

Persons having skill in the art will further appreciate that detachable razors 102 can be manufactured and implemented to the present invention through numerous means known and appreciated in the art. In one embodiment of the invention, the detachable razor 102 uses a disposable, three blade cartridge razor system with a lubricating strip that, when wet, serves to lubricate the skin for shaving. In another embodiment of the invention, the detachable razor 102 uses a disposable, four blade razor system. However, other embodiments of the invention can employ razors with varying numbers of blades. In other embodiments of the invention, the materials can vary. Other embodiments of the invention can accept razor blades made by other manufacturers. Other embodiments can employ a traditional safety razor with single razor blade and a protective device positioned between the edge of the blade and the skin.

Finally, persons skilled in the art will understand that numerous materials can be used to implement a detachable applicator brush 108. In one embodiment of the invention, the material used is a synthetic material such as, but not limited to, thermoplastic polymers such as, but not limited to, nylons. In other embodiments, the detachable applicator brush can use horsehair bristles, badger hair bristles, or boar hair bristles. The detachable applicator brush 108 can be assembled to have varying brush shapes and sizes depending on user demand.

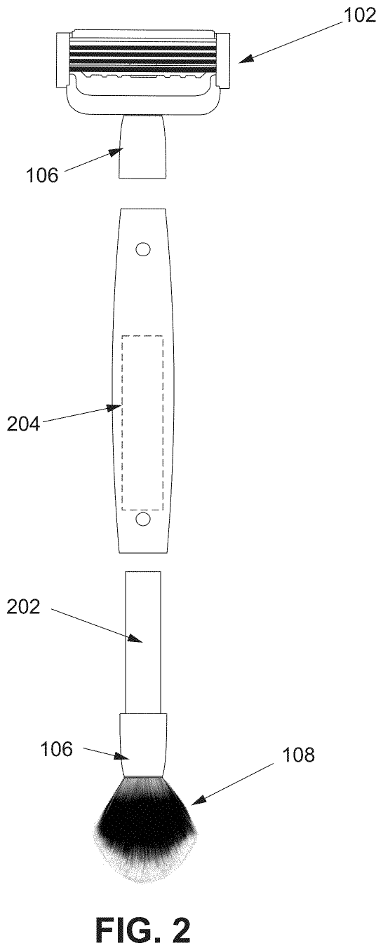

FIG. 2 is a front exploded view of the all-in-one shaving system in accordance with an embodiment of the invention. In the preferred embodiment of the invention, the detachable applicator brush 108 and the attachment shroud 106 attach to a disposable shaving cream or gel reservoir 202. In embodiments of the invention, the detachable razor 102 and the detachable applicator brush are secured to the hollow handle 104 by an attachment shroud 106. Such an attachment shroud may connect to the hollow handle by numerous means such as, but not limited to, a simple screw mechanism, a bayonet mount, or a spring-loaded latch mechanism. Such an attachment shroud 106 also serves as a waterproof barrier for the hollow handle 104. In such a spring-loaded latch mechanism, the detachable razor 102 and the detachable brush 108 can detach from the hollow handle by the press of a button 110.

In one embodiment of the invention, a heating element 204 is located inside the hollow handle. A heating element 204 is capable of heating the shaving liquid or gel or fluid to a temperature conducive to, and comfortable for, shaving. In such an embodiment, a heating element can consist of a rechargeable battery, a resistive circuit and a switch. Persons skilled in the art will appreciate that the hollow handle can serve as an insulator to retain heat.

In one embodiment of the invention, a custom impact resistant case to contain the said all-in-one shaving system and protect said shaving system from impacts with other objects is included. Such a custom impact resistant case can include a battery charging mechanism for the heating element 204. Persons having skill in the art will readily appreciate that numerous means are available to provide a charging mechanism such as, but not limited to, an AC adapter or a rechargeable battery chargeable by an AC power supply.

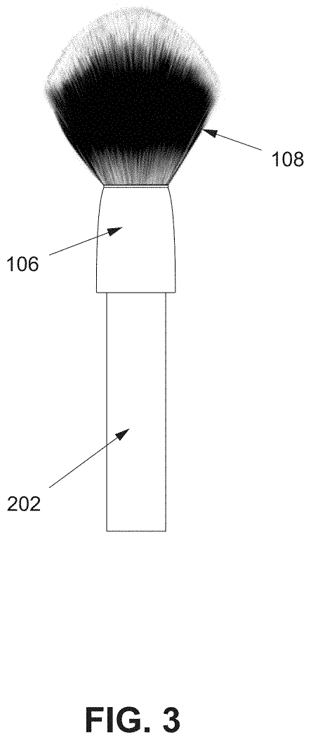

FIG. 3 is a front view of an applicator brush and shaving cream or gel reservoir for an all-in-one shaving system in accordance with an embodiment of the invention. In this view, the detachable applicator brush 108 and the attachment shroud 106 attach to a shaving cream or gel reservoir 202. In the preferred embodiment of the invention, the applicator brush and shaving cream or gel reservoir form and can serve as a separate, single unit which can detach from the razor and hollow body to serve as a single unit capable of applying shaving cream or gel to the face with the user being able to use the brush assembly to create a lather for shaving. In an embodiment of the invention, the neck assembly (or the attachment shroud assembly and the detachable razor) can remain attached to the hollow handle and used separately from the applicator brush and shaving cream or gel reservoir.

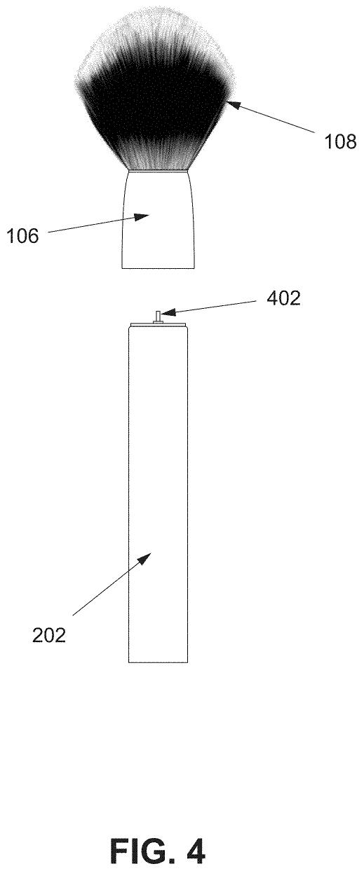

FIG. 4 is a front exploded view of an applicator brush and shaving cream and gel reservoir for an all-in-one shaving system in accordance with an embodiment of the invention. In an embodiment of the invention, a foot includes the attachment shroud assembly 106 attachable to the opposite end of the said hollow handle as the neck, including a shaving brush 108, a valve housing, and a travel passage through which the shaving liquid travels from the valve assembly of the disposable shaving reservoir cartridge 202 and into the shaving brush 108. In this view, the detachable applicator brush 108 is attached to an attachment shroud 106. A shaving cream or gel reservoir 202 attaches to the detachable applicator brush through an attachment means. Persons having skill in the art will readily appreciate that numerous attachment means are available from which to implement such an attachment. In an embodiment of the invention, the shaving cream or gel reservoir is cylindrically shaped and made of a metal such as steel or stainless steel. However, other embodiments can be made from plastics or other suitable materials. In one embodiment, the dimensions of the shaving cream and gel reservoir are 21 mm length by 9 mm diameter. Such a reservoir is capable of holding roughly 15 ml or roughly one-half ounce of shaving liquid or shaving cream or shaving gel. The size of the shaving cream and gel reservoir is designed to hold enough shaving cream or shaving gel for at least three shaves without becoming overly cumbersome or bulky.

In the preferred embodiment of the invention, the shaving cream or gel reservoir 202 is of a size conducive to fitting inside the hollow handle of the exemplary all-in-one shaving system. In embodiments of the invention, the shaving cream or gel reservoir 202 includes a valve 402 which will allow for the efficient dispensation of an amount of shaving cream or gel. The valve 402 includes a passageway for shaving cream or gel to travel through the attachment shroud assembly and through the detachable applicator brush 106 and into the bristles of the said brush. Persons having skill in the art will readily appreciate that such a passageway could consist of a simple opening or a tube or tube-like assembly. Other embodiments of the invention may include different means of dispensing shaving cream or gel into the detachable applicator brush 106. Those means include, but are not limited to, a simple tube mechanism to a syringe mechanism. Persons having skill in the art will understand that such a size will limit the amount of shaving cream or gel to a finite volume of shaving cream or gel.

In the preferred embodiment, the shaving cream or gel reservoir will hold enough shaving cream or gel to provide for at least three shaves. In one embodiment of the invention, the shaving cream or gel is mixed with a carrier gas such as, but not limited to, carbon dioxide so as to provide for the easy dispensation of shaving cream or gel. In another embodiment of the invention, the shaving cream or gel is mixed with a carrier liquid such as, but not limited to, propane so as to provide for the easy dispensation of shaving cream or gel. Persons skilled in the art will readily appreciate that numerous carrier liquids or gases can be used to efficiently transfer shaving liquid from a disposable shaving cream or gel reservoir to a shaving brush.

Use of the exemplary all-in-one shaving system is designed to be as simple as possible. A user can simply dispense shaving cream or gel by either pushing a button or pulling a lever or spring-loaded mechanism to release shaving cream or gel which travels through a valve and through the bristles of the detachable applicator brush. In one embodiment of the invention, a user can pull the attachment shroud having the applicator brush with the thumb and forefinger towards the hollow handle. In another embodiment, a user can use a squeezing technique with the thumb and forefinger to release shaving liquid. A user has the option of detaching the detachable applicator brush and shaving cream or gel reservoir or simply leaving it in place.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the exemplary a all-in-one shaving system, other equivalent or alternative methods of implementing the all-in-one shaving system according to the present invention will be apparent to those skilled in the art. Various aspects of the invention have been described above by way of illustration, and the specific embodiments disclosed are not intended to limit the invention to the particular forms disclosed. The particular implementation of the all-in-one shaving system may vary depending upon the particular context or application. By way of example, and not limitation, the an all-in-one shaving system described in the foregoing was principally directed to men's grooming products. However, similar techniques may instead be applied to other applications such as women's shaving accessories which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the invention are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A shaving system comprising:
a. hollow handle;
b. a razor assembly attachable to one end of the said hollow handle including an attachment shroud and razor blade movably attachable to the said attachment shroud and pivotally positioned for use in shaving;
c. a shaving brush assembly attachable to the opposite end of the said hollow handle as the said neck, said shaving brush assembly including an attachment shroud assembly attachable to the opposite end of the said hollow handle as the said razor assembly, a shaving brush, a disposable shaving liquid reservoir cartridge, a valve housing located on the interior of the said attachment shroud assembly, and a travel passage through the said attachment shroud assembly which said shaving liquid travels from the valve assembly of the said disposable shaving reservoir cartridge and into the said shaving brush; and
d. a shaving liquid dispensing mechanism, said shaving liquid dispensing mechanism in communication with the said disposable shaving liquid reservoir, wherein said shaving liquid in said reservoir is dispensed upon activation of the said shaving liquid dispensing mechanism withdraws shaving liquid from said disposable shaving liquid reservoir cartridge through the said shaving liquid travel passage to the said shaving brush.

2. The shaving system of claim 1 wherein the components of the said shaving brush assembly are connectable to form an independent shaving brush assembly including a handle created from the said disposable reservoir cartridge.

3. The shaving system of claim 2 wherein the shaving brush assembly including a handle created from the disposable reservoir cartridge, the attachment shroud assembly and the shaving liquid dispensing mechanism is configured in such a manner so as to connect with the hollow handle, with the said disposable shaving liquid reservoir cartridge slidably attachable inside the said hollow handle.

4. The shaving system of claim 1 wherein the hollow handle is ergonomically shaped in a manner conducive to shaving.

5. The shaving system of claim 1 wherein the hollow handle and the razor assembly can attach to one another and be used as a razor independent from the shaving brush assembly.

6. The shaving system of claim 1 wherein the disposable shaving liquid reservoir cartridge is configured to contain a shaving liquid compound and a pressurized carrier gas and includes a valve assembly which mates with the valve housing inside the attachment shroud assembly attachable to the opposite end of the hollow handle.

7. The shaving system of claim 1 wherein the disposable shaving liquid reservoir cartridge is configured to contain a shaving liquid compound and a pressurized carrier liquid and includes a valve assembly which mates with the valve housing inside the attachment shroud assembly attachable to the opposite end of the hollow handle.

8. The shaving system of claim 1 wherein the shaving liquid dispensing mechanism includes a valve lever mechanism located in the attachment shroud assembly attachable to the opposite end of the said hollow handle as the said razor assembly.

9. An all-in-one shaving system comprising:
a. a hollow handle;
b. a neck including an attachment shroud assembly attachable to one end of the said hollow handle;
c. a razor blade assembly movably attachable to the said neck and pivotally positioned for use in shaving;
d. a disposable shaving liquid reservoir cartridge including a valve assembly located at the top of the said disposable shaving liquid reservoir cartridge can be removably housed within the said hollow handle, said disposable shaving liquid reservoir cartridge configured to contain a shaving liquid compound and a pressurized carrier;
e. a foot including an attachment shroud assembly attachable to the opposite end of the said hollow handle as the said neck, said attachment shroud assembly including a shaving brush, a valve housing, and a travel passage through which said shaving liquid travels from the valve assembly of the said disposable shaving reservoir cartridge and into the said shaving brush; and
f. a shaving liquid dispensing mechanism, said shaving liquid dispensing mechanism in communication with the said disposable shaving liquid reservoir, wherein said shaving liquid in said reservoir is depressurized and wherein activation of the said shaving liquid dispensing mechanism withdraws shaving liquid from said shaving liquid reservoir through the said shaving liquid travel passage to the said shaving brush.

10. The all-in-one shaving system of claim 9 wherein the disposable reservoir cartridge, the attachment shroud assembly, the shaving liquid dispensing mechanism are connectable to form an independent shaving brush assembly including a handle created from the said disposable reservoir cartridge.

11. The all-in-one shaving system of claim 10 wherein the independent shaving brush assembly including a handle created from the disposable reservoir cartridge, the attachment shroud assembly and the shaving liquid dispensing mechanism is configured in such a manner so as to connect with the hollow handle, with the said disposable shaving liquid reservoir cartridge slidably attachable inside the said hollow handle.

12. The all-in-one shaving system of claim 9 wherein the hollow handle is ergonomically shaped in a manner conducive to shaving.

13. The all-in-one shaving system of claim 9 wherein the hollow handle and the razor assembly can attach to one another and be used separately as a razor independent from the attachment shroud assembly.

14. The all-in-one shaving system of claim 9 wherein the razor blade assembly is a cartridge-type razor blade assembly.

15. The all-in-one shaving system of claim 9 wherein the razor blade assembly is a safety razor-type razor blade assembly.

16. The all-in-one shaving system of claim 9 wherein the carrier in the disposable shaving liquid reservoir cartridge is a pressurized gas.

17. The all-in-one shaving system of claim 9 wherein the carrier in the disposable shaving liquid reservoir cartridge is a pressurized liquid.

18. The all-in-one shaving system of claim 9 wherein a heating element is located inside the hollow handle used to warm shaving liquid inside the disposable shaving liquid reservoir cartridge.

19. The all-in-one shaving system of claim 9 further comprising a custom impact resistant case to contain the said all-in-one shaving system and protect said shaving system from impacts with other objects.

20. A method of shaving using an all-in-one shaving system having a hollow handle, a neck attachable to one end of the said hollow handle, a razor blade movably attachable to the said neck and pivotally positioned for use in shaving, a disposable shaving liquid reservoir cartridge including a valve assembly removably housed within said handle, said disposable shaving liquid reservoir cartridge configured to contain a shaving liquid compound and a pressurized carrier gas, a attachment shroud assembly attachable to the opposite end of the said hollow handle as the said neck, said attachment shroud assembly including a shaving brush, a valve housing, and a travel passage through which said shaving liquid travels from the valve assembly of the said disposable shaving reservoir cartridge and into the said shaving brush, and a shaving liquid dispensing mechanism, said shaving liquid dispensing mechanism in communication with the said disposable shaving liquid reservoir, wherein said shaving liquid in said reservoir is depressurized and wherein activation of the said shaving liquid dispensing mechanism withdraws shaving liquid from said shaving liquid reservoir through the said shaving liquid travel passage to the said shaving brush; said method comprising the steps of:
a. releasing the said shaving liquid from the said disposable shaving liquid reservoir to the said shaving brush;
b. applying the said shaving liquid released into the said shaving brush to a specific area of the body;
c. using the razor blade to shave the said specific area of the body.
